(19) United States
(12) Patent Application Publication
(10) Pub. No.: US 2016/0080901 A1
(43) Pub. Date: Mar. 17, 2016

(54) ELECTRONIC DEVICE AND POSITIONING METHOD

(71) Applicant: Chiun Mai Communication Systems, Inc., New Taipei (TW)

(72) Inventor: YU-AN CHUNG, New Taipei (TW)

(21) Appl. No.: 14/584,454

(22) Filed: Dec. 29, 2014

(30) Foreign Application Priority Data
Sep. 11, 2014 (CN) 201410460899.5

(51) Int. Cl. H04W 4/02; H04W 64/00; H04L 29/06

(52) U.S. Cl. CPC H04W 4/023; H04L 69/22; H04W 64/00; H04W 88/02

(57) ABSTRACT

An electronic device receives data packets from wireless devices. The electronic device parses the data packets of each wireless device to obtain position information of each wireless device. The electronic device calculates a position of the electronic device according to the position information of each wireless device.

### CROSS-REFERENCE TO RELATED APPLICATIONS

This application claims priority to Chinese Patent Application No. 201410460899.5 filed on Sep. 11, 2014, the contents of which are incorporated by reference herein.

### FIELD

Embodiments of the present disclosure relate to network technology, and particularly to an electronic device and a positioning method using the electronic device.

### BACKGROUND

Electronic devices (for example, mobile phones) typically determine a position using a global positioning system (GPS) device. However, the position obtained by the GPS device may indicate a large area. That is, the large area indicated by the position from the GPS may not be specific to a particular location.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device connected to wireless devices.

FIG. 2 is a block diagram of one embodiment of a positioning system in the electronic device.

FIG. 3 is a flowchart of an example embodiment of a positioning method using the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

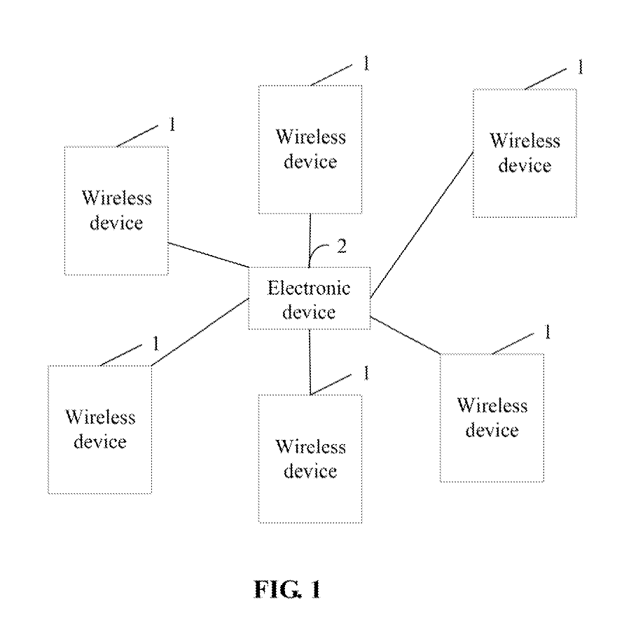

FIG. 1 is a block diagram of an example embodiment of an electronic device 2 connected to one or more wireless devices 1. In the example embodiment, the electronic device 2 is wirelessly connected to the wireless devices 1 using a wireless network. The electronic device 2 can be, but is not limited to, a mobile phone, a tablet computer, a personal digital assistant (PDA) device, a personal computer or any other electronic devices which provide functions of network connections. The wireless devices 1 can be, but are not limited to, routers, mobile phones or any other electronic devices which provide functions of network connections. In addition, each wireless device 1 includes a global positioning system (GPS), which is used for obtaining position information of the wireless device 1. The position information of the wireless device 1 includes a longitude and a latitude of the wireless device 1. The wireless network can be, but is not limited to, a wireless personal area network (PAN), a wireless local area network (LAN), a wireless mesh network, a wireless metropolitan area network, a wireless wide area network (WAN), a cellular network or the like.

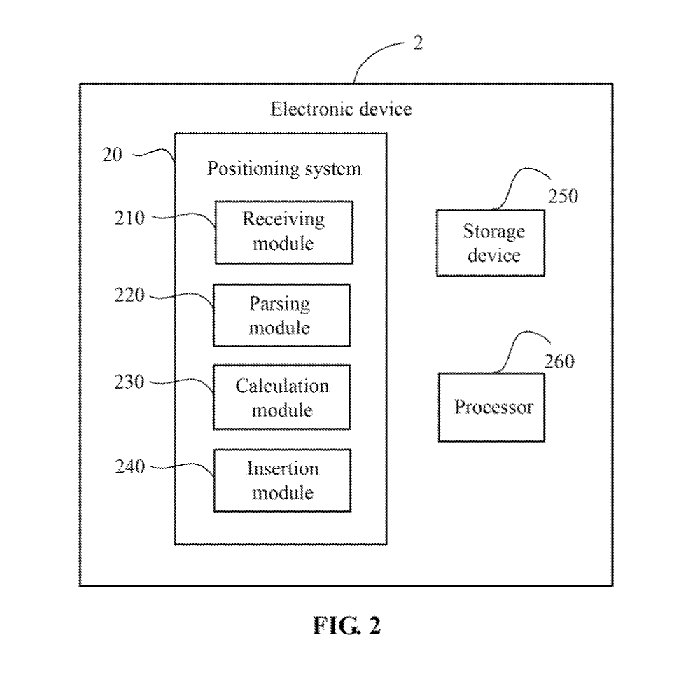

FIG. 2 is a block diagram of one embodiment of a positioning system 20 in the electronic device 2. The electronic device 2 includes, but is not limited to, a positioning system 20, a storage device 250, and at least one processor 260. FIG. 2 illustrates only one example of the electronic device 2, and other examples can comprise more or fewer components that those shown in the embodiment, or have a different configuration of the various components.

In one embodiment, the storage device 250 can be an internal storage device, such as a flash memory, a random access memory (RAM) for temporary storage of information, and/or a read-only memory (ROM) for permanent storage of information. The storage device 250 can also be an external storage device, such as an external hard disk, a storage card, or a data storage medium. The at least one processor 260 can be a central processing unit (CPU), a microprocessor, or other data processor chip that performs functions of the electronic device 2.

The positioning system 20 comprises, but is not limited to, a receiving module 210, a parsing module 220, a calculation module 230, and an insertion module 240. Modules 210-240 can comprise computerized instructions in the form of one or more computer-readable programs that can be stored in a non-transitory computer-readable medium, for example the storage device 250, and executed by the at least one processor 260 of the electronic device 2. A detailed description of the functions of the modules 210-240 is given below in reference to FIG. 1.

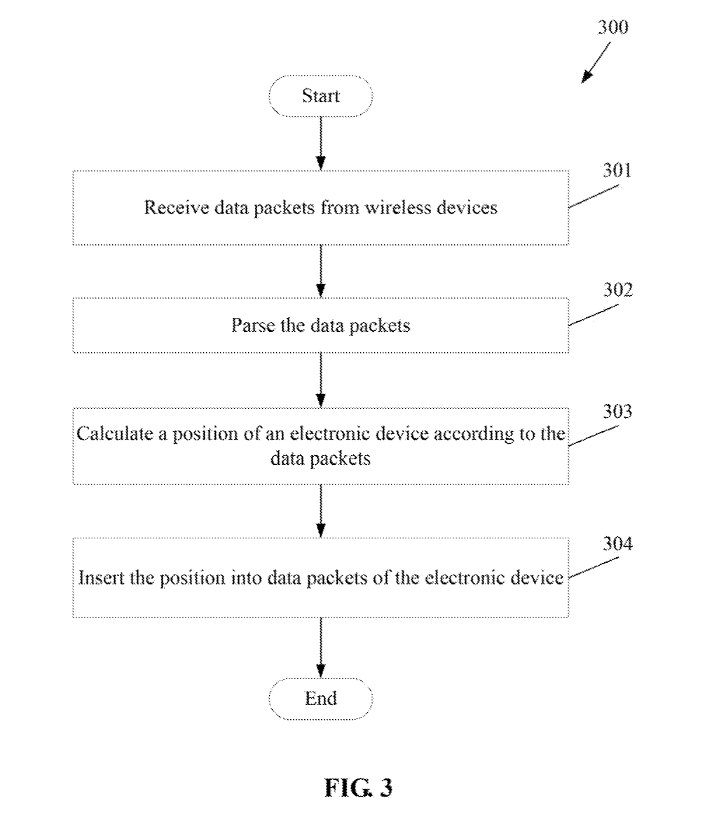

FIG. 3 illustrates a flowchart of an example embodiment of a positioning method 300 using an electronic device. In an example embodiment, the positioning method 300 is performed by execution of computer-readable software program codes or instructions by at least one processor of the electronic device, and can touch an electronic device based on images.

Referring to FIG. 3, a flowchart is presented in accordance with an example embodiment. The positioning method 300 is provided by way of example, as there are a variety of ways to carry out the method. The positioning method 300 described below can be carried out using the configurations illustrated in FIGS. 1-3, for example, and various elements of these figures are referenced in explaining positioning method 300. Each block shown in FIG. 3 represents one or more processes, methods, or subroutines, carried out in the positioning method 300. Furthermore, the illustrated order of blocks is illustrative only and the order of the blocks can be changed. Additional blocks can be added or fewer blocks can be utilized without departing from this disclosure. The example positioning method 300 can begin at block 301.

At block 301, a receiving module receives data packets from wireless devices through a wireless network. As shown in FIG. 1, the receiving module receives the data packets from six wireless devices. In one embodiment, the electronic device searches for a signal emitted by each wireless device in a predetermined distance, for example, ten meters. The electronic device further determines if a strength of each signal falls within a predetermined range having the predetermined distance. If the strength of the signal emitted by one wireless device falls within the predetermined range, the wireless device is allowed to connect to the electronic device. The signal of each wireless device includes, but not limited to, a name of the wireless device, an Internet Protocol (IP) address, and a media access control (MAC) address. After the wireless device is allowed to connect to the electronic device, the wireless device can send the data packets to the electronic device according to the IP address of the wireless device. In addition, the data packets of each wireless device include position information. In one embodiment, the data packets of each wireless device follows open systems interconnection (OSI) protocols and includes seven layers, which are a physical layer, a data link layer, a network layer, a transport layer, a session layer, a presentation layer, and an application layer. The position information of each wireless device may be included in the data link layer of the data packets of the wireless device.

At block 302, a parsing module parses the data packets of each wireless device to obtain position information of each wireless device. In one embodiment, the parsing module parses the data link layer of the data packets of each wireless device to obtain the position information of each wireless device.

At block 303, a calculation module calculates a position of the electronic device according to the position information of each wireless device. In at least one embodiment, the position of the electronic device can be an average of the longitudes of all wireless devices and an average of the latitudes of all wireless devices. For example, the position of the electronic device is the average of the longitudes and the latitudes of six wireless devices as shown in FIG. 1. In at least another embodiment, the position of the electronic device can be calculated by the position information of each wireless device and the strength of the signal of each wireless device. For example, the position of the electronic device can be calculated by a formula as follows:

$$x = \frac{{\sum }_{i = 0}^{n} {k}_{i} {x}_{i}}{n} , y = \frac{{\sum }_{i = 0}^{n} {k}_{k} {y}_{i}}{n} , {k}_{i} = a * {d}_{i} + A ,$$

where n is an amount of the wireless devices, x is a longitude of the electronic device, y is a latitude of the electronic device, xi is a longitude of the i^{th} wireless device, yi is a latitude of the i^{th} wireless device, ki is a signal parameter of the it^{h} wireless device, a and A are constant values, di is a strength of the signal of the i^{th} wireless device.

At block 304, an insertion module inserts the position of the electronic device into data packets of the electronic device. The data packets of the electronic device can be transmitted to other devices, for example, a tablet computer, so that the other devices can determine a position according to the position of the electronic device. For example, each of the other devices uses the block 303 to calculate a position of each of the other devices according to the position of the electronic device.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An electronic device comprising:
at least one processor; and
a storage device that stores one or more programs, which when executed by the at least one processor, cause the at least one processor to:
receive data packets from wireless devices connected to the electronic device;
parse the data packets of each wireless device to obtain position information of each wireless device; and
calculate a position of the electronic device according to the position information of each wireless device.

2. The electronic device of claim 1, wherein the at least one processor further inserts the position of the electronic device into data packets of the electronic device.

3. The electronic device of claim 2, wherein the data packets of the electronic device are transmitted to other devices, and each of the other devices calculates a position of each of the other devices according to the position of the electronic device.

4. The electronic device of claim 1, wherein the position information of each wireless device comprises a longitude and a latitude of the wireless device.

5. The electronic device of claim 4, wherein the position of the electronic device is an average of the longitudes of all wireless devices and an average of the latitudes of all wireless devices.

6. The electronic device of claim 4, wherein the position of the electronic device is calculated by the position information of each wireless device and a strength of a signal emitted by each wireless device.

7. The electronic device of claim 6, wherein the position of the electronic device is calculated by a formula as follows:
$$x = \frac{{\sum }_{i = 0}^{n} {k}_{i} {x}_{i}}{n} , y = \frac{{\sum }_{i = 0}^{n} {k}_{k} {y}_{i}}{n} , {k}_{i} = a * {d}_{i} + A ,$$
wherein n is an amount of the wireless devices, x is a longitude of the electronic device, y is a latitude of the electronic device, xi is a longitude of the i^{th} wireless device, yi is a latitude of the i^{th} wireless device, ki is a signal parameter of the i^{th} wireless device, a and A are constant values, and di is a strength of the signal of the i^{th} wireless device.

8. The electronic device of claim 6, wherein the wireless device is connected to the electronic device upon a condition that the strength of the signal emitted by the wireless device falls within a predetermined range.

9. A computer-based positioning method using an electronic device, the positioning method comprising:
receiving data packets from wireless devices connected to the electronic device;
parsing the data packets of each wireless device to obtain position information of each wireless device; and
calculating a position of the electronic device according to the position information of each wireless device.

10. The method of claim 9, further comprising:
inserting the position of the electronic device into data packets of the electronic device.

11. The method of claim 10, wherein the data packets of the electronic device are transmitted to other devices, and each of the other devices calculates a position of each of the other devices according to the position of the electronic device.

12. The method claim 9, wherein the position information of each wireless device comprises a longitude and a latitude of the wireless device.

13. The method of claim 12, wherein the position of the electronic device is an average of the longitudes of all wireless devices and an average of the latitudes of all wireless devices.

14. The method of claim 12, wherein the position of the electronic device is calculated by the position information of each wireless device and a strength of a signal emitted by each wireless device.

15. The method of claim 14, wherein the position of the electronic device is calculated by a formula as follows:
$$x = \frac{{\sum }_{i = 0}^{n} {k}_{i} {x}_{i}}{n} , y = \frac{{\sum }_{i = 0}^{n} {k}_{k} {y}_{i}}{n} , {k}_{i} = a * {d}_{i} + A ,$$
wherein n is an amount of the wireless devices, x is a longitude of the electronic device, y is a latitude of the electronic device, xi is a longitude of the i^{th} wireless device, yi is a latitude of the i^{th} wireless device, ki is a signal parameter of the i^{th} wireless device, a and A are constant values, and di is a strength of the signal of the i^{th} wireless device.

16. The method of claim 14, wherein the wireless device is connected to the electronic device upon a condition that the strength of the signal emitted by the wireless device falls within a predetermined range.

17. A non-transitory computer-readable medium having stored thereon instructions that, when executed by at least one processor of an electronic device, causing the electronic device to perform a positioning method, the positioning method comprising:
receiving data packets from wireless devices connected to the electronic device;
parsing the data packets of each wireless device to obtain position information of each wireless device; and
calculating a position of the electronic device according to the position information of each wireless device.

18. The non-transitory computer-readable medium of claim 17, wherein the positioning method further comprises:
inserting the position of the electronic device into data packets of the electronic device.

19. The non-transitory computer-readable medium of claim 18, wherein the data packets of the electronic device are transmitted to other devices, and each of the other devices calculates a position of each of the other devices according to the position of the electronic device.

20. The non-transitory computer-readable medium of claim 17, wherein the position information of each wireless device comprises a longitude and a latitude of the wireless device.
